(19) United States
(12) Patent Application Publication
(10) Pub. No.: US 2002/0006532 A1
(43) Pub. Date: Jan. 17, 2002

(54) Bonded LTD-resistant zirconia dental components

(76) Inventor: Arnaud Robin, Evreux (FR)

Correspondence Address: Michael L. Goldman, Esq., NIXON PEABODY LLP, Clinton Square, P.O. Box 31051, Rochester, NY, 14603, US

(21) Appl. No.: 09/842,259

(22) Filed: Apr. 25, 2001

Related U.S. Application Data
(60) Provisional application No. 60/199,703, filed on Apr. 26, 2000.

(51) Int. Cl. A61C 13/09; C04B 35/48; B32B 27/06; B44C 1/22

(52) U.S. Cl. 428/697; 501/103; 501/32; 106/35; 428/702; 216/28; 216/31

(57) ABSTRACT

The present invention relates to a yttria doped tetragonal zirconia (YTZP) dental component including a ceramic having a bulk portion having a glassy phase and a bonding surface, wherein the bonding surface has been etched of glass.

The present application claims benefit of U.S. patent application Ser. No. 60/199,703, filed Apr. 26, 2000, which is hereby incorporated by reference in its entirety.

### FIELD OF THE INVENTION

The present invention relates to bonded, zirconia dental components which are resistant to low temperature degradation and methods for making them.

### BACKGROUND OF THE INVENTION

A vital requirement for ceramic dental components is that they suitably bond to teeth or other dental structures. For example, a ceramic post must bond well not only to the tooth but also to other prosthetic components such as caps and crowns, while components such as ceramic inlays, onlays, caps, crowns, and bridges must bond well to a tooth or teeth. Many conventional methods of bonding common dental oxide ceramics (such as silica) to other dental components are known. For example, in one conventional method, a resin such as acrylic or epoxy is used to bond the silica-based dental component to a tooth.

Because of its high strength, colorability, and transparency, partially stabilized zirconia ceramics are being increasingly considered for use as dental components. Unfortunately, it has been found that straightforward application of the methods for bonding conventional silica dental ceramics to partially stabilized zirconia ceramics results in poorly bonded composites. Therefore, there is a need to develop a bonding system suitable for bonding dental zirconia components to other dental structures.

Kern et al., Dent. Mater. 14(1):64-71 (1998) recognizes the particular problem of bonding zirconia dental components and proposes adopting adhesive bonding methods used for glass-infiltrated alumina dental ceramics for the bonding of partially stabilized zirconia (yttria doped tetragonal zirconia polycrystals; YTZP) dental ceramics. In particular, Kern investigated the suitability to zirconia of many different conventional adhesion protocols conventionally used for alumina ceramics. These protocols included: a) sandblasting the zirconia surface prior to applying the BisGMA bonding resin, b) additionally applying silane or acrylizing the zirconia surface after sandblasting but before application of the resin, and c) coating the sandblasted-zirconia surface with either tribochemical silica, phosphate-containing monomers, or polyacidmodified resins instead of the resin. With the exception of the protocol involving the phosphate-containing monomer, Kern reports that the tensile strength of the resulting bonded structures unacceptably degraded over time. Concerning the phosphate-containing monomer protocol, Kern reported a 17% decrease in bond strength but found this to be statistically insignificant, and concluded that the resulting bonded structure possessed an acceptable tensile strength which remained durable over time.

However, Kern reported that the failure mechanism for the phosphate monomer structures was completely cohesive in the monomer, suggesting that bonding systems involving this special phosphate monomer may have the disadvantage that the monomer itself degrades over time.

It has been reported that biomedical grade YTZP zirconias such as PROZYR have superior mechanical strength as compared to conventional dental ceramics and their use as dental components has been suggested. However, the problems of bonding YTZP zirconias reported by Kern et al., Dent. Mater. 14(1):64-71 (1998) were not recognized or discussed.

Therefore, there remains a need for developing a bonding system suitable for bonding YTZP zirconia dental components to other dental structures.

The present invention is directed to overcoming these and other deficiencies in the art.

### SUMMARY OF THE INVENTION

In accordance with the present invention, selecting a YTZP zirconia which is highly resistant to low temperature degradation (LTD) will enhance both the strength and the stability of bonds in bonded zirconia dental structures.

In particular, the present inventors considered the stability of the bond strength to be critically dependent upon the susceptibility of the zirconia material to low temperature degradation (LTD). Although YTZP zirconia ceramics are known to have high strength and toughness, they are also known to be susceptible to strength degradation upon exposure to steam in the temperature range of about 100-500° C. The origin of this LTD phenomenon is attributed to a reaction between water and Zr—O—Zr bonds of the ceramic. This reaction causes a transformation of zirconia grains from their desired tetragonal state to their monoclinic state. This transformation is also accompanied by a volume expansion in the transformed grain of about 4%, which causes microcracking in the component and consequent strength degradation.

Without wishing to be bound by theory, in the dental system, it is believed that the environmental conditions present in the mouth are such that LTD may occur in the zirconia dental components and this LTD phenomenon may impact the strength of the YTZP-resin bond. In particular, the temperatures in the mouth are about 37° C., and these conditions are typically simulated by thermal cycling between about 5° C. and 55° C. Although these temperatures are somewhat below those typically associated with the LTD phenomenon, Chevalier et al., Bioceramics 10:135-138 (1997), which is hereby incorporated by reference in its entirety, have suggested that LTD may also occur in some YTZP zirconias at temperatures as low as 37° C. Thus, it is believed that LTD may act upon YTZPs in dental systems. In regard to YTZP-resin bonds, it is believed that LTD of the YTZP may cause general microcracking in the vicinity of the transformed grain and in particular at the uncracked surface of the YTZP material, and that this microcracking degrades the adhesive bond strength of the system and allows for further ingress of water into the zirconia material, thereby accelerating the spread of LTD.

Because the present invention prevents the initial cause of the bond strength degradation, bonded zirconia dental structures containing resins which are less susceptible than the phosphate monomers of Kern et al., Dent. Mater. 14(1):64-71 (1998), which is hereby incorporated by reference in its entirety, to self-dissolution in water can be used without fear of degradation.

In general, conventional YTZP ceramics having a surface monoclinic content of no more than 40% after exposure to five cycles of 134° C. steam at 2 bars for 20 hours possess the needed LTD resistance to make them suitable for use in the present invention. Preferably, the YTZP ceramic has a surface monoclinic content of no more than 10% after exposure to five cycles of 134° C. steam at 2 bars for 20 hours, more preferably less than 5%.

This LTD resistance can be achieved by controlling the mean grain size of the YTZP grains to less than 0.6 μm, as measured by the linear intercept method.

In addition, this discovery is not at all appreciated by the conventional understanding in this art. Kern et al., Dent. Mater. 14(1):64-71 (1998), which is hereby incorporated by reference in its entirety, believed that the reason for long term failure of the bonded structure was due to water ingress at the resin-zirconia bond interface followed by dissolution of the bond. Kern did not at all appreciate the possibility that the specific zirconia used could have been susceptible to LTD. This lack of appreciation of the criticality of selecting an LTD resistant material is reflected by Kern's selection of a material which has a large grain size (1 μm). It is known that large grains are more susceptible to transformation than smaller grains. See, e.g, FIG. 2 of Cales, Encyclopaedic Handbook of Biomaterials and Bioengineering, Vol. 1, Part B (1995), which is hereby incorporated by reference in its entirety. In fact, Kern teaches away from the present invention by suggesting that small grain size and high density are two reasons for the failure of the ROC system bonds, thereby dissuading the skilled artisan from using YTZPs which have a grain size of less than 1 micrometer (μm) and a high density.

Therefore, in accordance with the present invention, there is provided a dental system including a YTZP ceramic having a shape suitable for use as a dental component, the shape including a bonding surface, and resin bonded to the bonding surface of the YTZP ceramic, wherein the YTZP ceramic has a grain size of less than 0.6 mm, as measured by the linear intercept method.

The present invention also relates to a dental system including a YTZP ceramic having a shape suitable for use as a dental component, the shape including a bonding surface and a resin bonded to the bonding surface of the YTZP ceramic, wherein the YTZP ceramic has a surface monoclinc content of no more than 40% after exposure to five cycles of 134° C. steam at 2 bars for 20 hours.

Another aspect of the present invention relates to a YTZP dental component including a ceramic having a bulk portion having a glassy phase and a bonding surface, wherein the bonding surface has been etched of glass.

Yet another aspect of the present invention relates to a method of making a dental component including providing a dental component including a YTZP ceramic having a glassy phase, the ceramic having a bonding surface and exposing the bonding surface to an etchant capable of etching the glassy phase.

### DETAILED DESCRIPTION OF THE INVENTION

In some preferred embodiments, the YTZP material having high LTD resistance has very low porosity of less than 0.4 vol. %, preferably less than 0.1 vol.%. Without wishing to be bound by theory, it is believed that the transformation of the tetragonal grains to monoclinic initially occurs in the vicinity of surface pores. Therefore, eliminating these pores has a tendency to reduce the transformation to monoclinic. In some embodiments, pores in a pressureless sintered YTZP material (which typically possesses at least 0.5 vol. % porosity) may be eliminated by hot isostatic pressing that material to essentially full density.

In some preferred embodiments, the YTZP material having high LTD resistance has a small addition of alumina, on the order of between 0.02 wt. % and 0.2 wt. %, preferably between 0.05 wt. % and 0.15 wt. % alumina.

In a preferred embodiment, the grain size of the YTZP is less than 0.5 μm. The smaller grains of this preferred embodiment make the YTZP even more resistant to LTD phenomena. In more preferred embodiments, however, the grain size of the YTZP is between 0.32 μm and 0.45 μm. In this more preferred range, the grains are small enough to resist LTD but not so small as to eliminate the beneficial transformation capability which provides high strength and toughness. In general, actual grain size measurements (G) can be converted to average linear intercept measurements (L) by the following formula: G=1.56L.

In one preferred method of making the YTZP zirconia, a coprecipitated submicron powder comprising yttria and zirconia powder is provided, the powder is cold isostatically pressed at between 50 and 400 MPa and appropriately green machined to form a green dental component.

In another green forming method, the YTZP powder is combined with suitable plasticizers to form a plastic mixture, and the mixture is then placed in a conventional injection molding machine and injection molded to form a green dental component.

Once the green component is formed, it is then sintered at between about 1300° C. and 1500° C. for about 1 to 4 hours to achieve a density of at least 95%; and the sintered piece is hot isostatically pressed (“hipped”) in an inert gas such as argon at between 1300° C. and 1500° C. for between 0.5 and 4 hours to produce a sintered component having a density of at least 99.9%, and a grain size of less than 0.6 microns.

Next, a bonding surface on the sinter-hipped YTZP component is exposed to an etchant (such as HF) for a suitable time (such as 24 hours) in order to either remove the glassy phase from the microstructure of the bonding surface or to roughen the surface in a similar manner. A suitable resin is then applied to that etched bonding surface, and the composite is then joined to a dental structure such as a tooth or a post.

The YTZP dental component preferably comprises at least about 90 mol. % zirconia, and is preferably partially stabilized by yttria at a concentration of between about 2 mol. % and about 5 mol. %, more preferably comprising between about 2.5 mol. % and 3.5 mol. % yttria, most preferably comprising between about 2.8 mol. % and 3.2 mol. % yttria.

The bulk of the YTZP dental component should have a four point flexural strength of at least about 920 MPa, preferably at least 1300 MPa. Its density should be at least 99.6% of theoretical density, preferably at least 99.9%. Preferably, it should have an open porosity of no more than 0.1%. In some embodiments, the bulk has an elasticity modulus of no more than 220 GPa. Preferably, the bulk contains less than 2 wt. % oxide impurities which form a glassy phase, more preferably less than 1.0 wt. %, most preferably less than 0.5 wt. %. It typically has a fracture toughness of at least 5 MPa m^{½.}

The present invention also provides the artisan with an increased manufacturing flexibility to select an inexpensive bonding processes. Although etching is a common method of conditioning a ceramic surface in order to bond it to another material, the conventional understanding in the field of dental zirconia was that zirconia was not amenable to etching. In particular, Kern et al., Dent. Mater. 14(1):64-71 (1998), which is hereby incorporated in its entirety, reported that hydrofluoric etching enhances the resin bond to conventional silica-based ceramics, but does not improve the resin bond strength to zirconia ceramics. Accordingly, the art developed many complicated processes for the bonding of dental zirconia, as evidenced by those reported in Kern.

In accordance with the present invention, it is believed that etching the bonding surface of a fine grained YTZP dental component will substantially eliminate the glassy phase from the bonding surface, resulting in an appropriate level of porosity in the bonding surface which is sufficient to allow resin infiltration of the bonding surface, thereby producing a strong bond between the zirconia dental component and the resin.

Without wishing to be bound by theory, it is believed that prior efforts to suitably etch dental zirconia failed due to the incorrect selection of partially stabilized zirconias (PSZs) as the specific zirconia. Without wishing to be bound by theory, it is believed that the stabilized zirconias used were either magnesia-stabilized zirconias (Mg-PSZ) or calcia-stabilized zirconias (Ca-PSZ). Typically, PSZ materials are characterized by a coarse grained microstructure (on the order of 50 μm) containing significant residual intragranular porosity. In addition, due to the high sintering temperature needed to sinter PSZs, impurity diffusion at the grain boundaries often produces a significant glassy phase, thereby affecting mechanical properties.

Without wishing to be bound by theory, it is believed that the weak intergranular bonding of PSZ as well as its significant glass grain boundary phase are two reasons why the etching of PSZ materials does not provide a surface amenable to bonding. It is believed the weak intergranular bonds of the coarse PSZ grains are more easily broken during adhesion testing, thereby lowering overall bond strength. In addition, as etching typically acts to remove glassy phase, it is also believed that the etching-induced removal of the significant glassy phase present in PSZ further lowers the mechanical integrity of the PSZ material.

In contrast, the very fine microstructure of biomedical grade YTZP materials results in very strong intragranular bonding. In addition, the relative absence of a glassy phase in the YTZP material (less than 0.5 vol. %) means that the etching thereof does not remove too much glass and so the mechanical integrity of the YTZP is not significantly compromised by the etching action. For these two reasons, it is believed that etching of a YTZP dental component can provide a surface suitable for resin bonding while etching of PSZs does not.

Therefore, in accordance with the present invention, there is provided a YTZP dental component comprising a ceramic having a bulk portion having a glassy phase and a bonding surface, wherein the bonding surface has been etched of glass. Preferably, the YTZP ceramic has a grain size of less than 0.6 μm and less than 0.5 vol. % glassy phase.

The bonding surface of the zirconia dental component is typically characterized by a density of between 97% and 99.8% of theoretical density, preferably 99% and 99.5%. Preferably, the volume fraction of the glassy phase in the bonding surface is less than 50% of the volume fraction of the glassy phase in the bulk, more preferably, less than 10%. Typically, there is less than 100 ppm (or 0.01 wt. %) of glassy phase in the bonding surface.

It is believed if the porosity on the ceramic surface is too small (i.e., less than 1 μm in diameter), the resin will not tenaciously adhere to the ceramic surface. Conversely, if the porosity is too large (i.e., more than 10 μm), the resin must be applied in undesirably thick layers (i.e., more than 20 μm) in order to sufficiently to fill the surface pores. Only when the porosity was controlled to within a window (i.e., between about 1 μm and about 10 μm in diameter) may the resin be applied in economically thin layers and polished sufficiently smooth.

In light of the above discussion, the present invention also includes a method of making a dental component. This method involves providing a dental component including a YTZP ceramic having a glassy phase, the ceramic having a bonding surface and exposing the bonding surface to an etchant capable of etching the glassy phase.

In some embodiments, the method further includes applying a resin to the bonding surface.

In some embodiments, the method further includes bonding the applied resin to a tooth.

In some embodiments, the method further includes bonding the applied resin to a second dental component.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A dental system comprising:
a yttria doped tetragonal zirconia (YTZP) ceramic having a shape suitable for use as a dental component, the shape including a bonding surface, and
a resin bonded to the bonding surface of the YTZP ceramic, wherein the YTZP ceramic has a grain size, as measured by a linear intercept method, of less than 0.6 μm.

2. The dental system of claim 1, wherein the YTZP ceramic has a grain size, as measured by the linear intercept method, of less than 0.5 μm.

3. The dental system of claim 1 wherein the YTZP ceramic has less than 0.4 vol. % porosity.

4. The dental system of claim 1 wherein the YTZP ceramic comprises between 2.5 mol. % and 3.5 mol. % yttria.

5. The dental system of claim 1 wherein the YTZP ceramic further comprises between 0.02 wt. % and 0.2 wt. % alumina.

6. The dental system of claim 1 wherein the bonding surface of the YTZP ceramic has been etched.

7. A dental system comprising:
a yttria doped tetragonal zirconia (YTZP) ceramic having a shape suitable for use as a dental component, the shape including a bonding surface, and
a resin bonded to the bonding surface of the YTZP ceramic, wherein the YTZP ceramic has a surface monoclinic content of no more than 40% after exposure to five cycles of 134° C. steam at 2 bars for 20 hours.

8. The dental system of claim 7 wherein the YTZP ceramic has a grain size, as measured by a linear intercept method, of less than 0.6 μm.

9. The dental system of claim 7 wherein the YTZP ceramic has less than 0.4 vol. % porosity.

10. The dental system of claim 7 wherein the YTZP ceramic is a sinter-hipped ceramic.

11. The dental system of claim 7 wherein the YTZP ceramic further comprises between 0.02 wt. % and 0.2 wt. % alumina.

12. A yttria doped tetragonal zirconia (YTZP) dental component comprising a ceramic having a bulk portion having a glassy phase and a bonding surface, wherein the bonding surface has been etched of glass.

13. The YTZP dental component of claim 12 having a glassy phase of less than 2 vol. %.

14. The YTZP dental component of claim 12 having wherein the YTZP ceramic has a grain size, as measured by a linear intercept method, of less than 0.6 μm.

15. The YTZP dental component of claim 12 having a resin bonded to the bonding surface.

16. A method of making a dental component, comprising the steps of:
providing a dental component comprising a yttria doped tetragonal zirconia (YTZP) ceramic having a glassy phase, the ceramic having a bonding surface, and
exposing the bonding surface to an etchant capable of etching the glassy phase.

17. The method of claim 16 further comprising:
applying a resin to the bonding surface.

18. The method of claim 17 further comprising:
bonding the applied resin to a tooth.

19. The method of claim 17 further comprising:
bonding the applied resin to a second dental component.
